(19) United States
(12) Patent Application Publication
(10) Pub. No.: US 2016/0204556 A1
(43) Pub. Date: Jul. 14, 2016

(54) ELECTRICAL CONNECTOR

(71) Applicant: Chant Sincere Co., Ltd., New Taipei City (TW)

(72) Inventors: Yong-Sheng LIN, New Taipei City (TW); Yu Chin CHIEN, New Taipei City (TW); Cheng-Hui FAN, New Taipei City (TW)

(21) Appl. No.: 14/961,928

(22) Filed: Dec. 8, 2015

(30) Foreign Application Priority Data
Jan. 12, 2015 (TW) 104200375

(51) Int. Cl. H01R 24/38; H01R 13/52

(52) U.S. Cl. CPC H01R 24/38; H01R 13/5202; H01R 2101/00

(57) ABSTRACT

An electrical connector includes a connecting casing, a terminal assembly and a receiving member, in favor to attaching on a cable. Each rear end of a plurality of terminals of the terminal assembly protrude to a terminal carrier of the terminal assembly in furtherance to penetrate through the receiving member up till the terminals being exposed out of a rear-side socket of the connecting casing.

### CROSS-REFERENCE TO RELATED APPLICATIONS

This application claims the benefit of the filing date under 35 U.S.C. §119(a)-(d) of Taiwan Patent Applications No. 104200375, filed Jan. 12, 2015.

### BACKGROUND OF THE INVENTION

1. Field of the Invention

The present invention relates to a cable, and more particularly to an electrical connector assembled on a cable.

2. Description of the Related Art

A cable and an electronic device transmit signals via a connector assembly. The connector assembly includes an electrical connector and a socket connector compatible with the electrical connector. The electrical connector includes a metal casing, a plastic core body, terminals, and so on. For a conventional electrical connector, the transmission line of the cable need to be inserted into the electrical connector so as to be welded to connect to the terminals in the electrical connector, which leads to difficulty in wiring the electrical connector to the cable and the waste of time.

When cable signals, especially high frequency cable signals, pass through the electrical connector, coupling phenomenon occurs between terminals with short separation distances, which is a phenomenon called crosstalk. The coupling phenomena between terminals include capacitive coupling or inductive coupling, wherein capacitive coupling causes coupling current and inductive coupling causes coupling voltage, and both coupling current and coupling voltage result in unsteadiness or distortion of the signals.

### SUMMARY OF THE INVENTION

The present invention provides an electrical connector assembled on a cable, comprising: a connecting casing including a covering shell portion and a connecting portion, wherein the covering shell portion and the connecting portion are sleeved to each other in a front-rear direction and form an internal space penetrating the connecting casing in the front-rear direction, and the internal space has a front-side socket and a rear-side socket, in which the front-side socket is provided to connect a compatible electrical connector to the covering shell portion, and the rear-side socket is provided to connect the cable to the connecting portion; a terminal assembly including a terminal carrier, a plurality of terminal components extendedly disposed within the terminal carrier and a cross separator, wherein the terminal carrier is disposed in the internal space and is engaged with the connecting portion, and the cross separator has a plurality of separating walls extendedly disposed within the terminal carrier to separate the plurality of terminal components into predetermined sections; and a receiving member plugged in the rear-side socket, wherein each rear end of the plurality of terminal components is extended from the terminal carrier to penetrate through the receiving member so as to expose outside of the rear-side socket.

According to an aspect of the present invention, the electrical connector further comprises a tail section member with a cable receiving space passing through the tail section member in the front-rear direction, wherein a front end of the tail section member has a sleeve portion sleeving the connecting portion of the connecting casing.

According to an aspect of the present invention, the sleeve portion has an internal thread, and a rear end of the connecting portion has an external thread, by which the internal thread of the sleeve portion and the external thread of the connecting portion are screwed together in such a manner that the tail section member and the connecting casing are fixed and sleeved by each other.

According to an aspect of the present invention, a cross-sectional size of the cable receiving space of the tail section member is larger than a cross-sectional size of the cable so as to form a glue-filling gap between the tail section member and an outer surface of the inserted cable.

According to an aspect of the present invention, the electrical connector further comprises a sealing member plugged in a rear cable receiving socket of the cable receiving space of the tail section member so as to seal the cable receiving space.

According to an aspect of the present invention, the terminal carrier has an insertion space that substantially fits the shape of the plurality of separating walls of the cross separator.

According to an aspect of the present invention, a rear end of the covering shell portion has a riveting groove, and a front end of the connecting portion has a riveting bulge, by which the riveting bulge and the riveting groove are riveted together in such a manner that the covering shell portion and the connecting portion are fixed and sleeved by each other.

According to an aspect of the present invention, an inner surface of the connecting portion has an internal thread, and a rear end of the terminal carrier has a external thread, by which the internal thread of the connecting portion and the external thread of the rear end of the terminal carrier are screwed together in such a manner that the connecting portion and the terminal carrier are fixed and sleeved by each other.

According to an aspect of the present invention, the receiving member and the cross separator are configured to converge toward each other in the front-rear direction.

According to an aspect of the present invention, an external surface of the terminal carrier has a water-proofing ring that closely contacts the covering shell portion.

### BRIEF DESCRIPTION OF THE DRAWINGS

FIG. 1 is a perspective view of a combination of an electrical connector and a cable according to one embodiment of the present invention;

FIG. 2 is an exploded view of the electrical connector according to the embodiment of the present invention;

FIG. 3 is a cross-sectional view of the combination of the electrical connector and the cable according to the embodiment of the present invention;

FIG. 4 is a rear view of the electrical connector according to the embodiment of the present invention;

FIG. 5 is an assembly flow chart of the electrical connector according to the embodiment of the present invention;

FIG. 6 is a sectional view of a connecting casing of the electrical connector being assembled according to the embodiment of the present invention;

FIG. 7 is an exploded view of a terminal assembly of the electrical connector being assembled according to the embodiment of the present invention;

FIG. 8 is a schematic diagram of assembling the connecting casing and the terminal assembly of the electrical connector according to the embodiment of the present invention;

FIG. 9 is an assembly schematic diagram of the cable, a tail section member and a sealing member of the electrical connector according to the embodiment of the present invention;

FIG. 10 is a schematic diagram of the electrical connector and the sealing member being filled with glue according to the embodiment of the present invention;

FIG. 11 is a schematic diagram of the sealing member of the electrical connector being plugged into the gap according to the embodiment of the present invention.

### DETAILED DESCRIPTION OF THE EMBODIMENT(S)

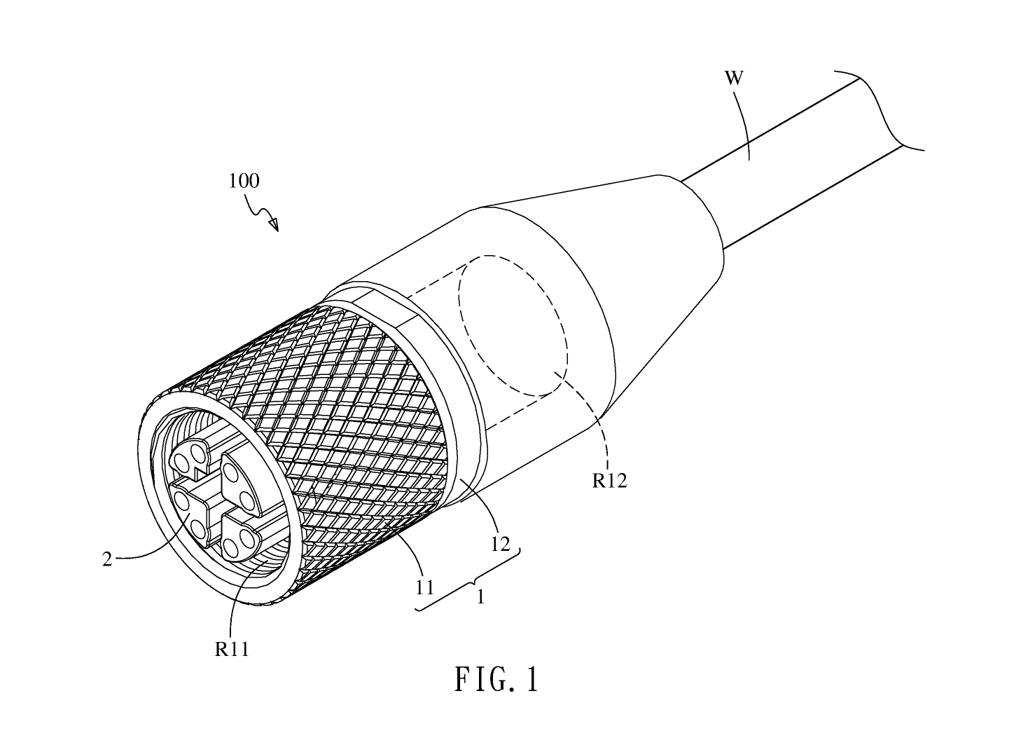

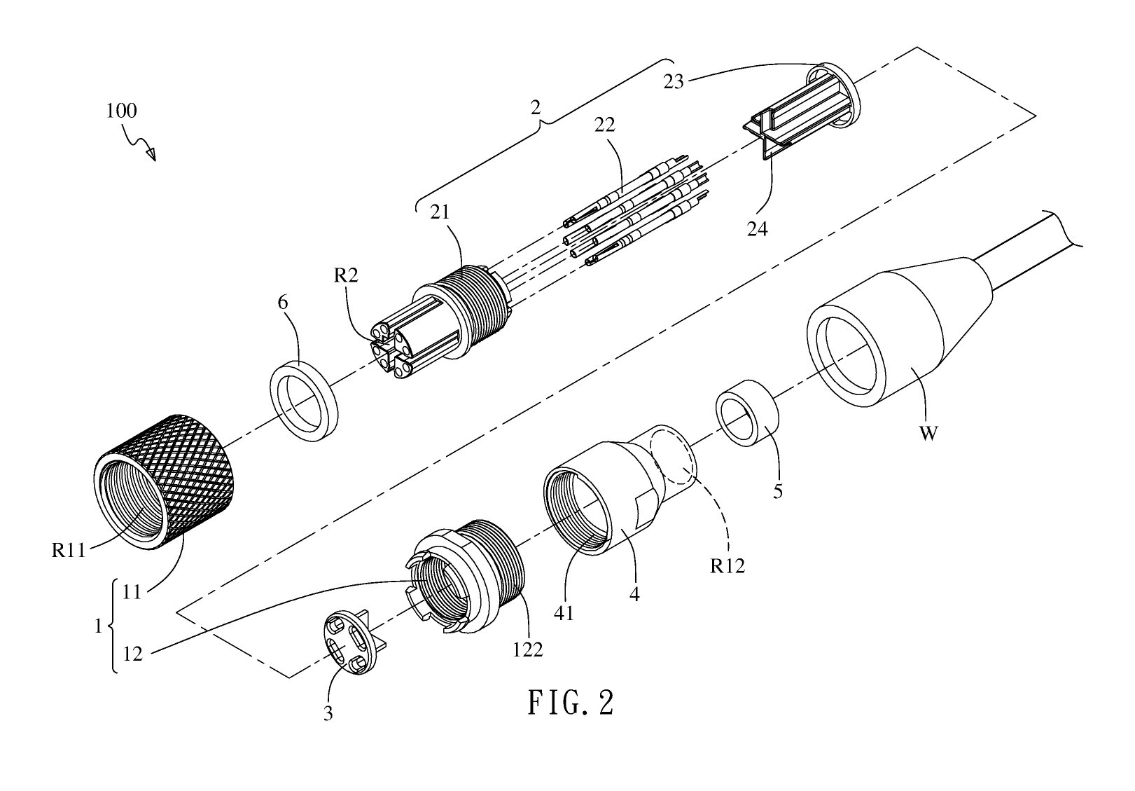

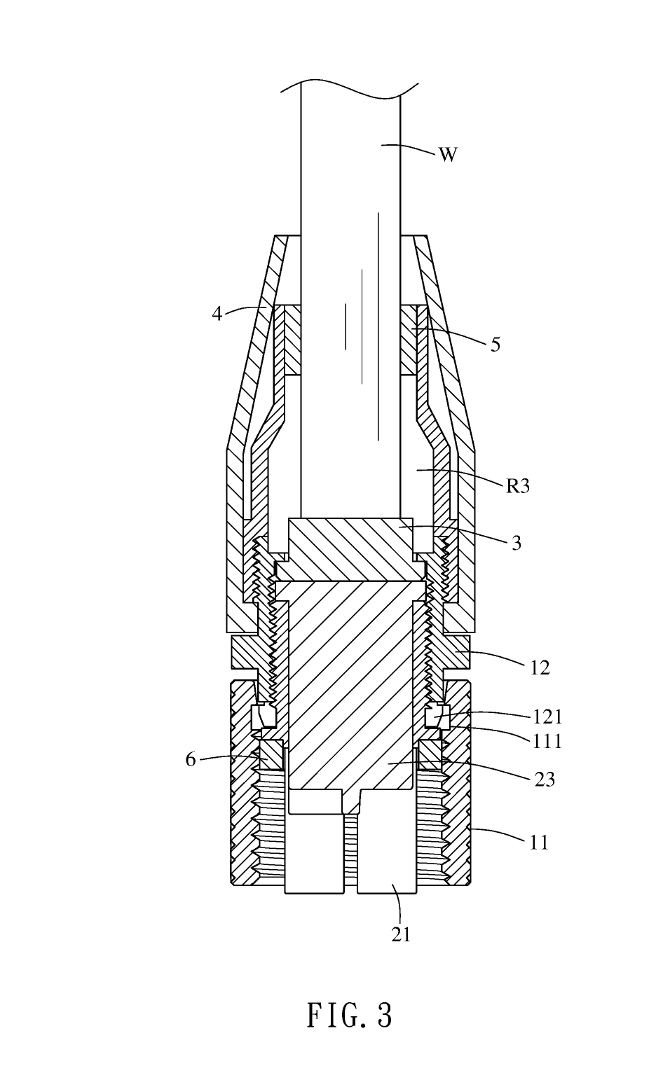

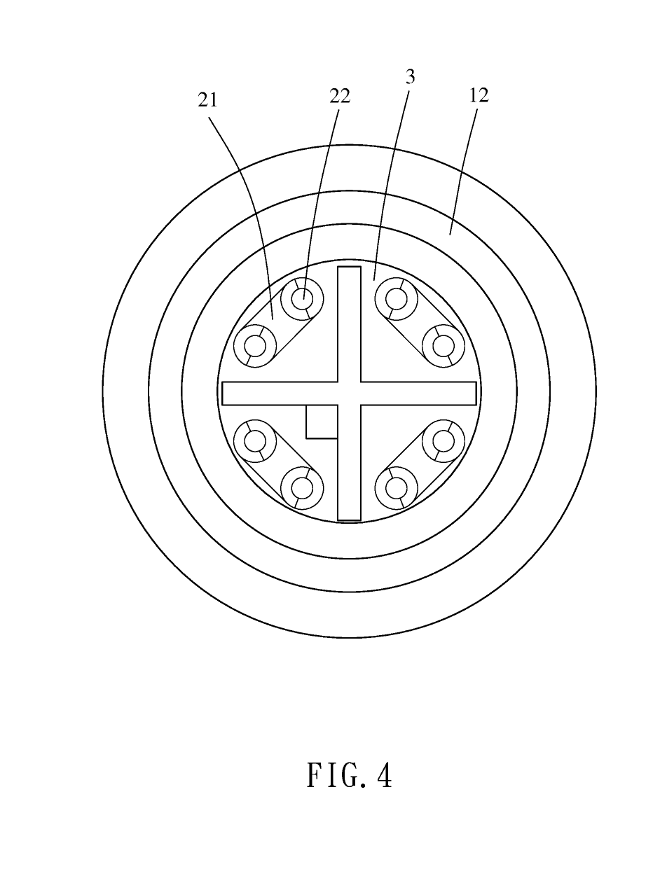

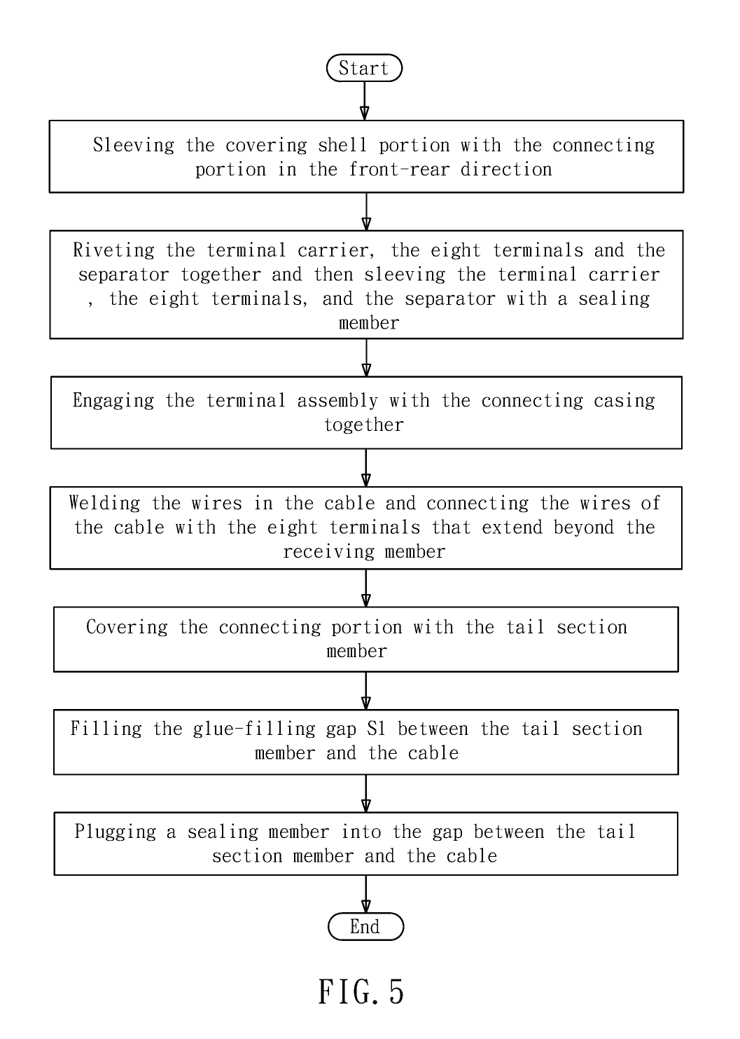

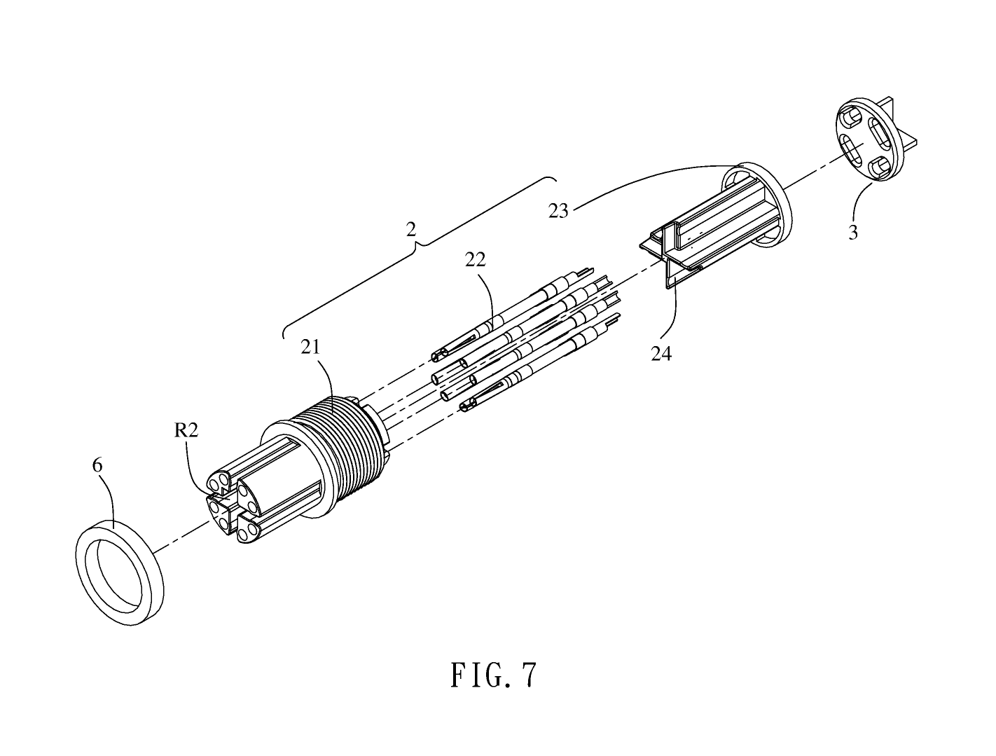

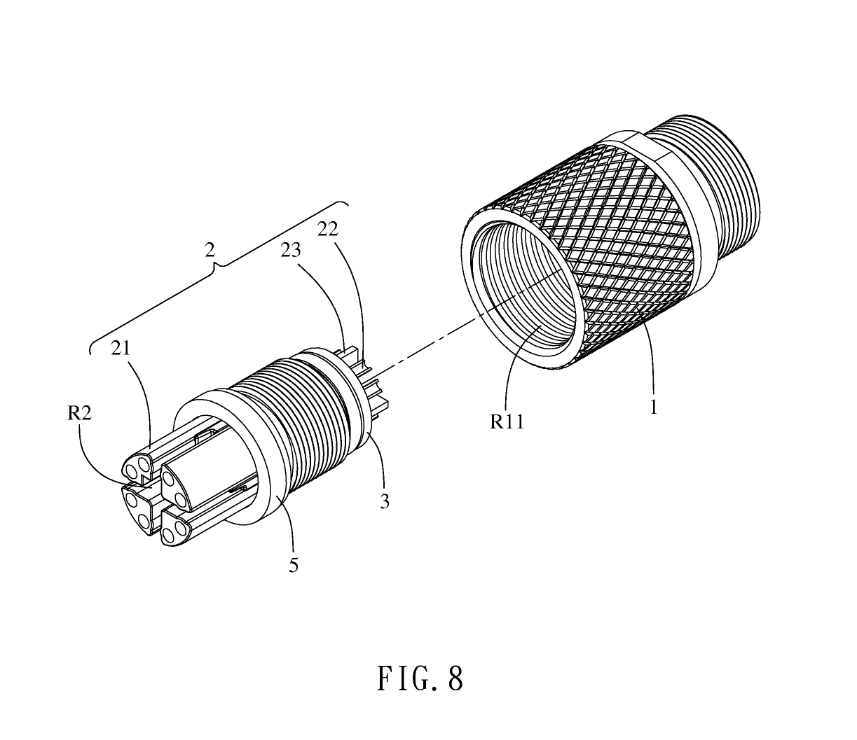

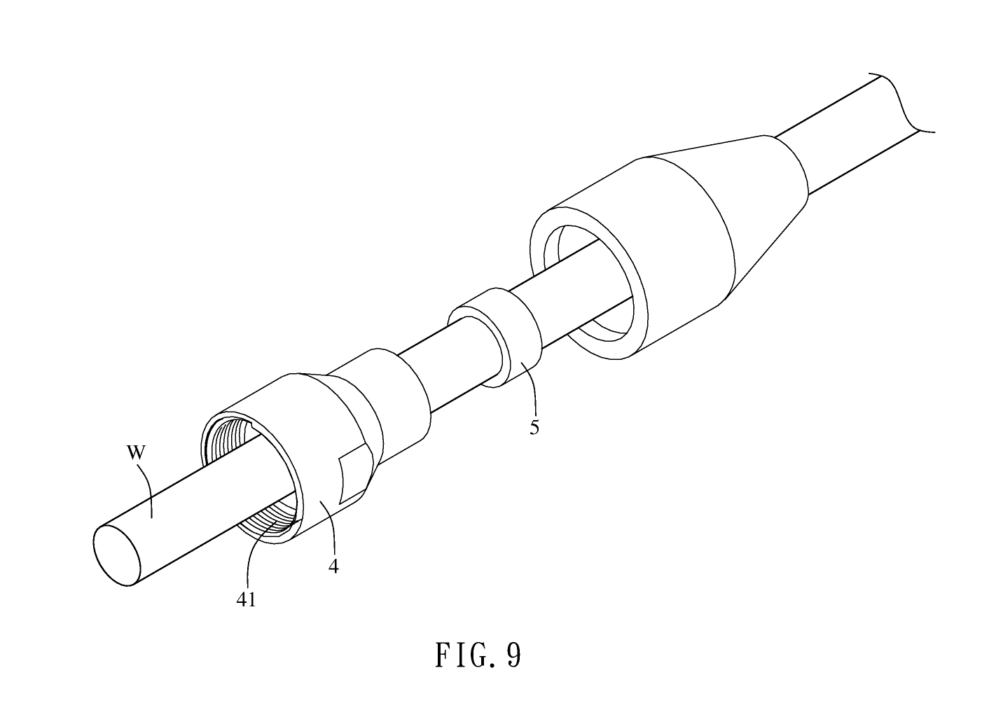

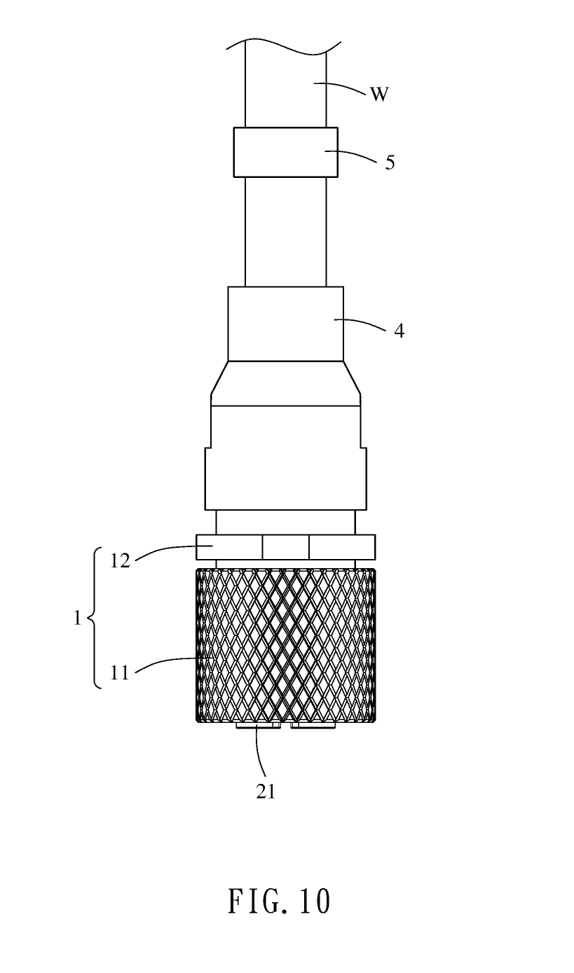

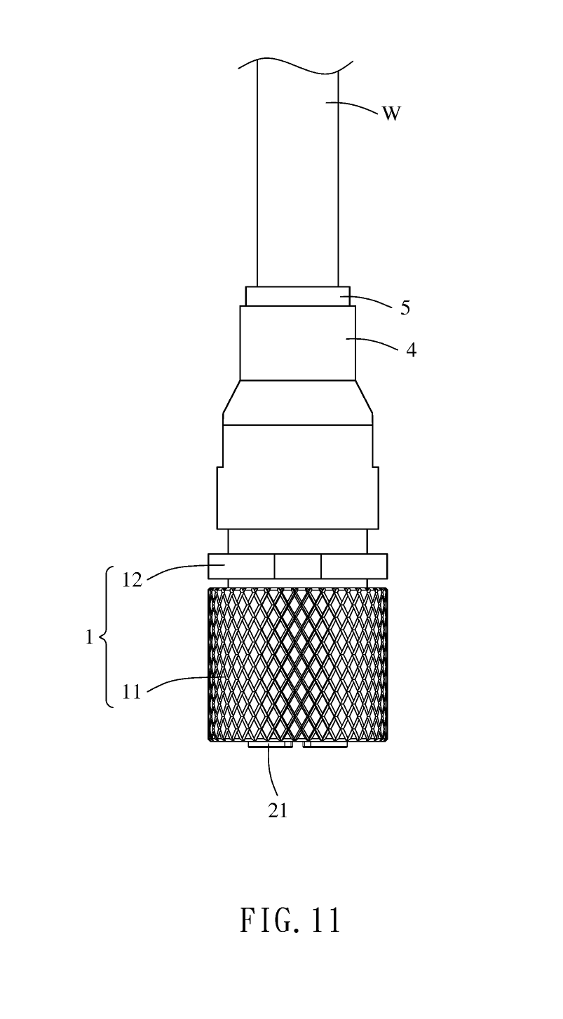

The preferred embodiments of the present invention are described in detail below with reference to FIG. 1 to FIG. 11. The description is used for explaining the embodiments of the present invention only, but not for limiting the scope of the claims.

As shown in FIG. 1 to FIG. 4, an electrical connector 100 of a cable W according to an embodiment of the present invention comprises: a connecting casing 1, a terminal assembly 2, and a receiving member 3.

The connecting casing 1 includes a covering shell portion 11 and a connecting portion 12, wherein the covering shell portion 11 and the connecting portion 12 are sleeved to each other in a front-rear direction and form an internal space (not shown) penetrating the connecting casing 1 in the front-rear direction. The covering shell portion 11 includes a front-side socket R11 and a rear-side socket R12, in which the front-side socket R11 is provided to connect a compatible electrical connector 100, and the rear-side socket R12 is provided to connect the cable W. Specifically, in this embodiment, a lower end of the covering shell portion 11 has a riveting groove 111, and two sides of a upper end of the connecting portion 12 has a riveting bulge 121, by which the riveting bulge 121 is riveted to the riveting groove 111. Preferably, the inner diameter of the covering shell portion 11 is larger than the outer diameter of the connecting portion 12, and the connecting portion 12 is an insulator such as plastic. It goes without saying that the present invention is not limited to this.

The terminal assembly 2 includes a terminal carrier 21, a plurality of terminals 22 extendedly disposed within the terminal carrier 21 and a cross separator 23, wherein the terminal carrier 21 is disposed in the internal space (not shown) and is engaged with the connecting portion 12. The plurality of terminals 22 is metal that transmits signals. In this embodiment, the quantity of the terminals is eight. The separating wall 231 is an insulator, which separates the plurality of terminals 22 to prevent the occurrence of crosstalk. The cross separator 23 has a plurality of separating walls 24 extendedly disposed within the terminal carrier 21 to separate the plurality of terminals 22 into predetermined sections. Selectively, an external surface of the terminal carrier 21 has a water-proofing ring 6 that closely contacts the covering shell portion 11.

Preferably, the material of the covering shell portion 1 of the connecting portion 1 is metal so as to provide electromagnetic shielding effect at the terminal assembly 2. In this embodiment, the terminal carrier 21 has an insertion space R2 that substantially fits the shape of the plurality of separating walls 24 of the cross separator 23, wherein the insertion space R2 is provided as a space into which the cross separator 23 is inserted.

The receiving member 3 is plugged in the rear-side socket R12, and the receiving member 3 has a plurality of openings for each rear end of the plurality of terminals 22 to extend through the receiving member 3 and be exposed to the outside. The rear end of the plurality of terminal components 22 is extended from the terminal carrier 21 and protrudes outside the rear-side socket R12 of the connecting portion 13. In this embodiment, the receiving member 3 has an opening compatible with the cross separator 23. It goes without saying that the present invention is not limited to this.

The receiving member 3 and the cross separator 23 are configured to converge toward each other in the front-rear direction.

Selectively, the electrical connector 100 of the present invention further includes a tail section member 4 with a cable receiving space passing through the tail section member 4 in the front-rear direction. A front end of the tail section member 4 has a sleeve portion 41 sleeving the connecting portion 12 of the connecting casing 1, wherein the sleeve portion 41 has an internal thread (not shown), and a rear end of the connecting portion 12 has an external thread 122, by which the internal thread and the external thread are screwed together in such a manner that the tail section member 4 and the connecting casing 1 are fixed and sleeved by each other. A cross-sectional size of the cable receiving space of the tail section member 4 is larger than a cross-sectional size of the cable W so as to form a glue-filling gap R3 between the tail section member 4 and an outer surface of the inserted cable W. Preferably, the electrical connector 100 further comprises a sealing member 5 plugged in a rear cable receiving socket of the cable receiving space of the tail section member 4 so as to seal the cable receiving space. In this embodiment, the sealing member 5 is an 0 ring made of elastic material such as rubber or silicone.

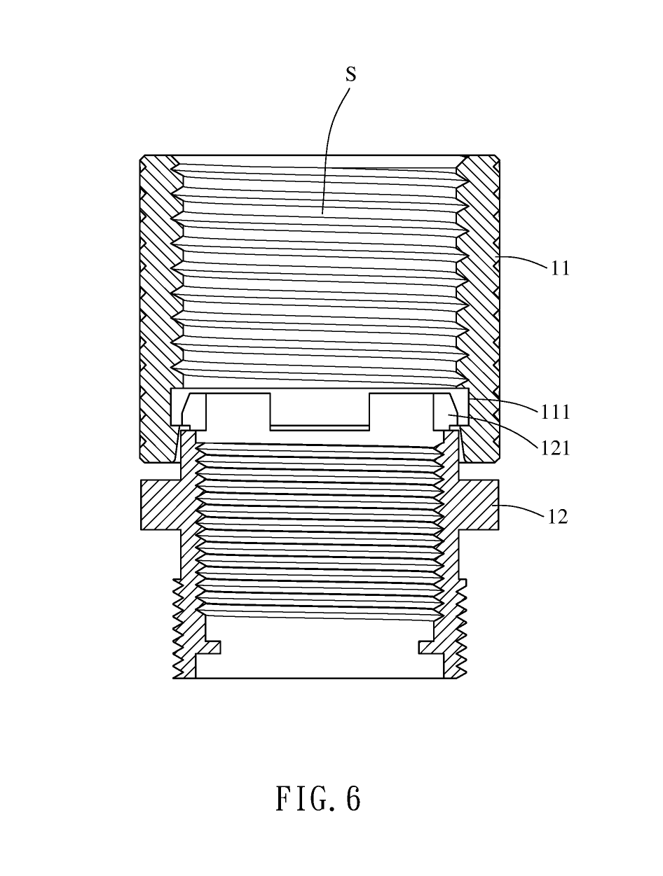

As shown in FIG. 6 to FIG. 11, steps of assembling a electrical connector 10 are described in detail as follows: at the beginning of the assembling, sleeving the covering shell portion 11 with the connecting portion 12 first in the front-rear direction (step S1), wherein riveting is a generally adopted way of fixation after the sleeving action. The connecting casing 1 is formed after combining the covering shell portion 11 and the connecting portion 12.

Furthermore, there is with respect to riveting the terminal carrier 21, the eight terminals 22 and the separator 23 together and then sleeving the terminal carrier 21, the eight terminals 22, and the separator 23 with a sealing member 5 (step S2). The terminal assembly 2 is formed after the combination.

After the connecting casing 1 and the terminal assembly 2 are formed, engaging the terminal assembly 2 with the connecting casing 1 together (step S3), welding the wires in the cable W and connecting the wires of the cable W with the eight terminals 22 that extend beyond the receiving member 3 (step S4), covering the connecting portion 12 with the tail section member 4 (step S5), and filling the glue-filling gap S1 between the tail section member 4 and the cable W (step S6) with glue. At last, there is with respect to plugging a sealing member 5 into the gap between the tail section member 4 and the cable W.

Needless to say, the wiring steps of the present invention are not limited to the above-described steps. In other embodiment, the order of step Si and step S2 can be exchanged or can be done in parallel.

To sum up, by the structure of the said electrical connector 100 in which the terminals 22 extends beyond the rear-side socket R12 of the electrical connector 100, the insertion of the cable W in the wiring procedure is omitted, which facilitates the connection between the terminals 22 and the cable W and shortens the assembly time. Furthermore, in the electrical connector 100 of the present invention, the terminals 22 are divided by the cross separator 23 so as to avoid the occurrence of coupling phenomenon between the terminals 22, reducing or eliminating the crosstalk problem while transmitting high-frequency signals.

While the invention has been described in terms of various specific embodiments, those skilled in the art will recognize that the invention can be practiced with modification within the spirit and scope of the claims.

What is claimed is:

1. An electrical connector, which is attaching on a cable, comprising:
a connecting casing including a covering shell portion and a connecting portion, wherein said covering shell portion and said connecting portion sleeve to each other in a front-rear direction and form an internal space which is penetrating said connecting casing in the front-rear direction, said internal space including a front-side socket and a rear-side socket, wherein said front-side socket providing to connect to a compatible electrical connector with said covering shell portion, along with said rear-side socket providing to connect to a cable with said connecting portion;
a terminal assembly including a terminal carrier, a plurality of terminals which is extendedly disposed within said terminal carrier, and a cross separator, said terminal carrier being disposed in said internal space and engaged with said connecting portion, said cross separator being configured with a plurality of separating walls which is extendedly disposed within said terminal carrier adequate to separate said plurality of terminals into predetermined sections; and
a receiving member being disposed in said rear-side socket, wherein each rear end of said plurality of terminals protrude to said terminal carrier in furtherance to penetrate through said receiving member up till said terminals being exposed out of said rear-side socket.

2. The electrical connector of claim 1, further comprising a tail section member with a cable receiving space passing through said tail section member in the front-rear direction, wherein a front end of said tail section member has a sleeve portion sleeving said connecting portion of said connecting casing.

3. The electrical connector of claim 2, wherein said sleeve portion has an internal thread, and a rear end of said connecting portion has an external thread, by which said internal thread of said sleeve portion and said external thread of said connecting portion are screwed together in such a manner that said tail section member and said connecting casing are fixed and sleeved by each other.

4. The electrical connector of claim 2, wherein a cross-sectional size of said cable receiving space of said tail section member is larger than a cross-sectional size of said cable so as to form a glue-filling gap between said tail section member and an outer surface of said inserted cable.

5. The electrical connector of claim 2, further comprising a sealing member plugged in a rear cable receiving socket of said cable receiving space of said tail section member so as to seal said cable receiving space.

6. The electrical connector of claim 1, wherein said terminal carrier has an insertion space that substantially fits the shape of said plurality of separating walls of said cross separator.

7. The electrical connector of claim 1, wherein the rear end of said covering shell portion has a riveting groove, and the front end of said connecting portion has a riveting bulge, by which said riveting bulge and said riveting groove are riveted together in such a manner that said covering shell portion and said connecting portion are fixed and sleeved by each other.

8. The electrical connector of claim 1, wherein an inner surface of said connecting portion has an internal thread, and a rear end of said terminal carrier has an external thread, by which said internal thread of said connecting portion and said external thread of the rear end of said terminal carrier are screwed together in such a manner that said connecting portion and said terminal carrier are fixed and sleeved by each other.

9. The electrical connector of claim 1, wherein said receiving member and said cross separator are configured to converge toward each other in the front-rear direction.

10. The electrical connector of claim 1, wherein an external surface of said terminal carrier has a water-proofing ring that closely contacts said covering shell portion.
